(19) United States
(12) Patent Application Publication
(10) Pub. No.: US 2022/0287055 A1
(43) Pub. Date: Sep. 8, 2022

(54) APPARATUS AND METHODS FOR NEW RADIO SIDELINK CHANNEL STATE INFORMATION ACQUISITION

(71) Applicant: IDAC HOLDINGS, INC., Wilmington, DE (US)

(72) Inventors: Moon-il Lee, Melville, NY (US); Tao Deng, Roslyn, NY (US); Martino M. Freda, Laval (CA); Tuong Hoang, Montreal (CA); Chunxuan Ye, San Diego, CA (US)

(73) Assignee: IDAC HOLDINGS, INC., Wilmington, DE (US)

(21) Appl. No.: 17/634,724

(22) PCT Filed: Aug. 13, 2020
(86) PCT No.: PCT/US2020/046138

§ 371 Date: Feb. 11, 2022

Related U.S. Application Data
(60) Provisional application No. 62/886,740, filed on Aug. 14, 2019.
(60) Provisional application No. 62/930,970, filed on Nov. 5, 2019.
(60) Provisional application No. 62/975,497, filed on Feb. 12, 2020.

(51) Int. Cl. H04W 72/12; H04W 72/14; H04W 76/20

(52) U.S. Cl. CPC H04W 72/1263; H04W 72/14; H04W 72/1231; H04W 76/20; H04W 92/18

(57) ABSTRACT

A method for use in a wireless transmit/receive unit (WTRU) is disclosed. The WTRU is able to communicate with a network through sidelink (SL). The WTRU is configured with a set of scheduling request (SR) configurations. The method comprises: receiving, through the SL, (1) CSI reporting request which requests a CSI report and (2) CSI reporting latency information for the CSI report; starting a timer based on the received CSI reporting latency information; triggering a SR transmission specific to CSI reporting; and determining if a SL grant has been received before the time expires, wherein on a condition that the SL grant has been received before the timer expires, the method further comprises 205 transmitting the CSI report based on the SL grant; on a condition that no SL grant has been received before the timer expires, the method further comprises 206 dropping the CSI report.

### CROSS-REFERENCE TO RELATED APPLICATIONS

This application claims the benefit of U.S. Provisional Application No. 62/886,740, filed Aug. 14, 2019, U.S. Provisional Application No. 62/930,970, filed Nov. 5, 2019, and U.S. Provisional Application No. 62/975,497, filed Feb. 12, 2020, the contents of which are incorporated herein by reference.

### BACKGROUND

Vehicle-to-everything (V2X) communications architecture has been developed for wireless communication systems, including those which use an evolved packet core (EPC). V2X communications may include one or more of vehicle-to-vehicle (V2V) communications, vehicle-to-pedestrian (V2P) communications, vehicle-to-infrastructure (V2I) communications and vehicle-to-network (V2N) communications.

New Radio (NR) V2X may support two modes of operation, Mode 1 and Mode 2. Mode 1 is based on Long Term Evolution (LTE) V2X Mode 3 operation. For example, the network may schedule a sidelink (SL) resource via downlink (DL) downlink control information (DCI) signaling and a wireless transmit/receive unit (WTRU) may apply the received resource reservation for SL transmission. Mode 2 may use LTE Mode 4 as a baseline for semi-persistent scheduling. In Mode 4, the WTRU may autonomously select and reserve the resources from a configured resource pool. In an example, the configured resource pool may be a preconfigured resource pool. An autonomous resource reservation may be based on WTRU sensing to identify available candidate resources

### SUMMARY

A method for use in a wireless transmit/receive unit (WTRU) is disclosed. The WTRU is able to communicate with a network through sidelink (SL). The WTRU is configured with a set of scheduling request (SR) configurations. The method comprises: receiving, through the SL, (1) CSI reporting request which requests a CSI report, and (2) CSI reporting latency information for the CSI report; starting a timer based on the received CSI reporting latency information; triggering a SR transmission specific to CSI reporting; and determining if a SL grant has been received before the time expires, wherein on a condition that the SL grant has been received before the timer expires, the method further comprises 205 transmitting the CSI report based on the SL grant; on a condition that no SL grant has been received before the timer expires, the method further comprises 206 dropping the CSI report.

A wireless transmit/receive unit (WTRU) is disclosed. The WTRU is able to communicate with a network through sidelink (SL) and the WTRU is configured with a set of scheduling request (SR) configurations. The WTRU comprises: a transceiver configured to receive, through the SL, (1) CSI reporting request which requests a CSI report and (2) CSI reporting latency information for the CSI report; a processor configured to start a timer based on the received CSI reporting latency information; and trigger a SR transmission specific to CSI reporting; determine if a SL grant has been received before the time expires, wherein on a condition that a SL grant has been received before the timer expires, the processor is further configured to transmit, through the transceiver, the CSI report based on the SL grant; and on a condition that no SL grant has been received before the timer expires, the processor is further configured to drop the CSI report.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a flow chart illustrating a method in accordance with an embodiment of this disclosure;

FIG. 3 is a timing diagram illustrating an example of a channel state information (CSI) reporting time window;

FIG. 4 is a timing diagram illustrating an example of multiplexing of multiple CSI reportings; and

FIG. 5 is a timing diagram illustrating an example of multiplexed CSI reportings with a CSI reporting index.

### DETAILED DESCRIPTION

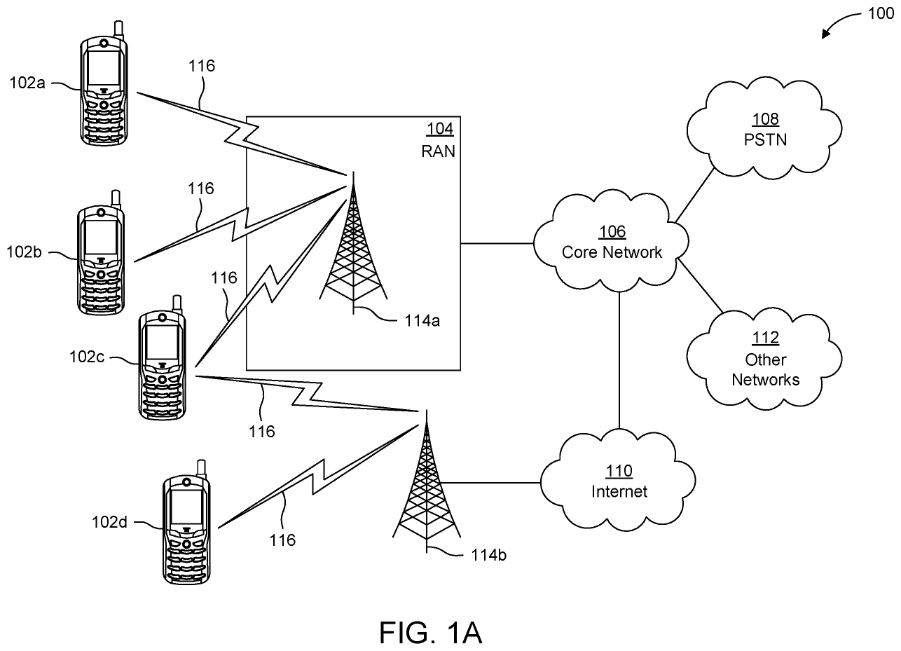

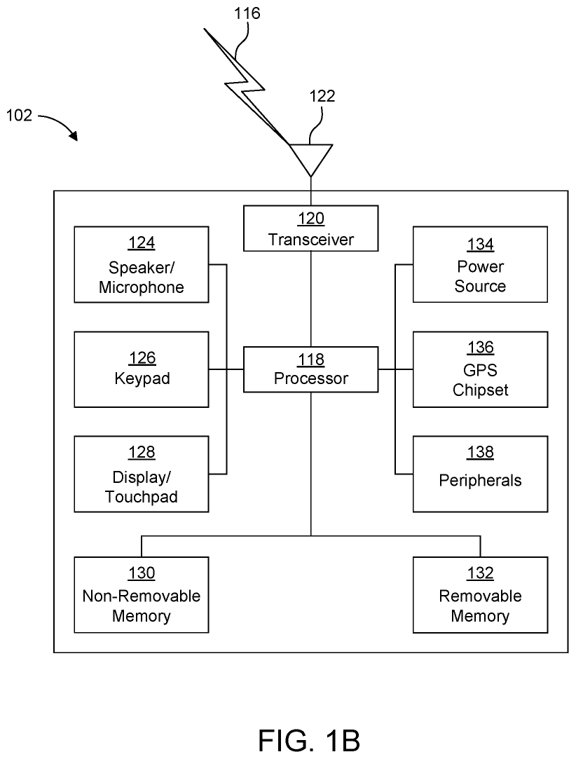

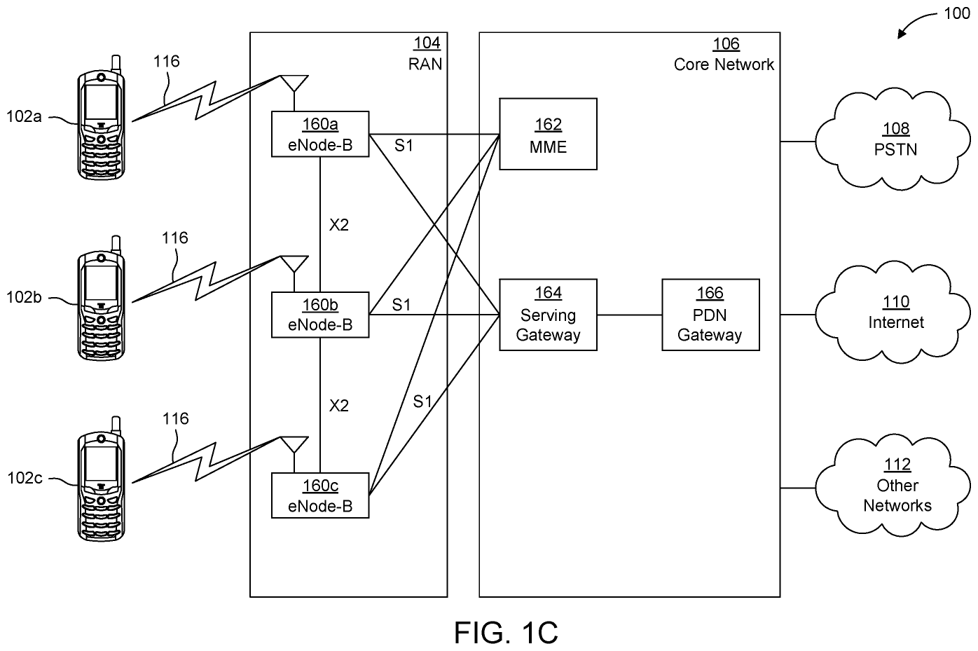

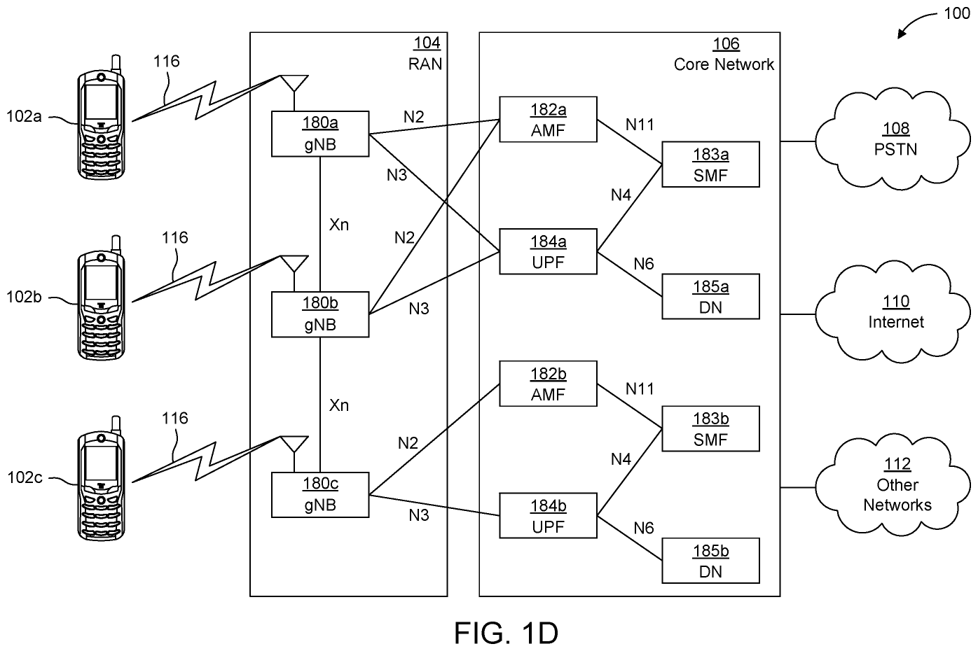

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a,184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

LTE vehicle-to-everything (V2X) communications may not support channel state information (CSI) acquisition. One reason for this lack of support may be that LTE V2X may apply to broadcast transmissions. NR V2X may support sidelink CSI acquisition for unicast transmission. In addition, NR CSI acquisition may include at least one of the following features: sidelink CSI reporting may be enable/disable by configuration; aperiodic CSI reporting; non-subband-based CSI; CSI reference signal (RS) transmission coupled with and confined within a physical sidelink shared channel (PSSCH) transmission (i.e., no stand-alone CSI-RS transmission); CSI may include a channel quality indicator (CQI) and a rank indicator (RI) with the number of rank supported up to 2; CQI and RI may be reported together; or CSI reporting may be delivered using a PSSCH and its resource allocation procedure.

NR V2X may support two modes of operation, Mode 1 and Mode 2. Mode 1 is based on Long Term Evolution (LTE) V2X Mode 3 operation. For example, the network may schedule a sidelink (SL) resource via downlink (DL) downlink control information (DCI) signaling and a WTRU may apply the received resource reservation for SL transmission. Mode 2 may use LTE Mode 4 as a baseline for semi-persistent scheduling. In Mode 4, a WTRU may autonomously select and reserve resources from a configured resource pool. In an example, the configured resource pool may be a preconfigured resource pool. An autonomous resource reservation may be based on WTRU sensing to identify available candidate resources. A WTRU can semi-persistently schedule a resource with a reservation interval. In other words, the WTRU can reserve the same resource once every reservation interval. Also, a WTRU may be configured with a resource re-selection counter and triggering conditions and will re-select resource when the counter expires or a triggering condition occurs. In an example, the WTRU may be preconfigured with the resource re-selection counter and triggering conditions.

Accordingly, the LTE Mode 4 semi-persistent scheduling may be suitable for NR SL periodic traffic. In addition, NR V2X may support many advanced use cases based on aperiodic traffic. Further, how Mode 2 operation may handle aperiodic traffic and corresponding resource reservation may vary.

There may be a problem with CSI-RS transmission instances. NR V2X SL may support CSI-RS transmission only together with PSSCH transmission. Thus, unlike NR Uu CSI-RS transmission, no periodical CSI-RS transmissions are available for a WTRU to regularly update CSI under SL. The PSSCH transmission instances may be based on the traffic pattern, for example, the periodicity and burstiness of the data. Sending a CSI-RS in each data transmission (i.e., each PSSCH transmission) may cause unnecessary overhead, for example when there is a large quantity of data to transmit in a slow-varying channel. It may also reduce resource utilization efficiency in Mode 2 operation considering the CSI reporting transmission.

Further, there may be a problem with non-sub-band CSI based on PSSCH transmission bandwidth. CSI-RS transmission may be confined within the PSSCH transmission. Thus, an associated reporting may be applicable to only the PSSCH resource allocation in the frequency domain. As the PSSCH resource allocation may be based on data packet size, a PSSCH transmission for a small packet may occupy one or a couple of sub-channels and thus may not provide accurate non-sub-band CSI reporting.

Higher congestion from CSI reporting may occur in some examples. A transmitting WTRU in sidelink unicast may trigger aperiodic CSI reporting for the sidelink which may increase congestion in the resource pool since a receiving WTRU triggered to report CSI may need to send a sidelink transmission even though the receiving WTRU may not have any packet to send.

In other examples, there may be a problem with CSI reporting timing. In NR V2X, no explicit CSI reporting may be used. Therefore, a transmitting WTRU may wait for the triggered CSI reporting indefinitely. A receiving WTRU may report the triggered CSI at any time the sidelink resource is available. In high mobility scenario, the delayed CSI feedback may be outdated and useless by the time the transmitting WTRU receives the CSI reporting.

In additional examples, there may be a problem with sidelink resource selection. In a WTRU autonomous resource selection, for example, in Mode-2, a WTRU may select one or more sidelink resources based on sensing. In the sensing procedure, a WTRU may first select a subset of subchannels based on reference signal received power (RSRP)/decoding of sidelink control information (SCI) and then the WTRU may select one or more subchannels randomly. In an example, the WTRU may select subchannels which have an RSRP below a threshold. However, the availability of CSI in each subchannel may not be taken into account.

A sidelink transmitting WTRU, a transmitting WTRU, a sender WTRU, a sidelink Tx WTRU, a Tx WTRU, and a first WTRU may be used interchangeably and still be consistent with the examples and embodiments provided herein. Also, a sidelink receiving WTRU, a receiving WTRU, a sidelink Rx WTRU, a Rx WTRU, a recipient WTRU, and a second WTRU may be used interchangeably and still be consistent with the examples and embodiments provided herein.

Further, sidelink CSI may be used interchangeably with CSI and still be consistent with the examples and embodiments provided herein. In addition, a sidelink measurement reference signal for CSI measurement may be referred to as a sidelink CSI reference signal (S-CSI-RS) and may be used interchangeably with CSI-RS, and still be consistent with the examples and embodiments provided herein.

In addition, measurement reference signal (RS), sidelink measurement RS, CSI-RS, sidelink CSI-RS, S-CSI-RS, demodulation RS, DM-RS, sidelink DM-RS, S-DM-RS, PTRS, sidelink PTRS, S-PTRS, RLM-RS, sidelink RLM-RS, S-RLM-RS, RRM-RS, sidelink RRM-RS, S-RRM-RS, and beam reference signal may be used interchangeably and may still be consistent with the examples and embodiments provided herein. Further, CSI reporting, sidelink CSI reporting, CSI-RS transmission, sidelink CSI-RS transmission, indication of CSI-RS presence, and indication of sidelink CSI-RS presence may be used interchangeably and may still be consistent with the examples and embodiments provided herein.

Also, a measurement, RSRP, RSRQ, RSSI, L1-RSRP, and SINR may be used interchangeably and may still be consistent with the examples and embodiments provided herein. Moreover, a slot may be used interchangeably with a subframe, a radio frame, a logical slot, a sidelink slot, a Uu slot, a time slot, and a slot configured for a sidelink transmission, and may still be consistent with the examples and embodiments provided herein.

A CSI reporting index, CSI reporting identity, CSI reporting process, CSI process, and CSI process identity may be used interchangeably and may still be consistent with the examples and embodiments provided herein. Further, CSI reporting, CSI report, CSI feedback, and CSI reporting trigger may be used interchangeably and may still be consistent with the examples and embodiments provided herein.

In some embodiments, a sidelink reference signal for CSI measurement may be used. A sidelink CSI may be measured, estimated, or determined based on a reference signal for sidelink CSI measurement, wherein the reference signal for sidelink CSI measurement may be transmitted, signaled, received on a sidelink resource.

Accordingly, different sidelink CSI-RS types may be used. In some examples, one or more of the following may apply for sidelink CSI-RS. A transmitting WTRU may transmit CSI-RS on a sidelink resource, wherein the sidelink resource may be a resource used for PSSCH transmission. A CSI-RS may be located within a PSSCH resource used, selected, or determined. Further, one or more types of CSI-RS may be used.

A first type of CSI-RS may be a reference signal transmitted for CSI measurement and present only when CSI feedback is enabled or sidelink measurement is used. For example, radio link modulation (RLM) or radio resource management (RRM) may be used. The first type of CSI-RS may be an RS transmitted separately with a demodulation reference signal (DM-RS) for an associated sidelink channel, such as a PSSCH or a physical sidelink control channel (PSCCH). The associated sidelink channel may be a sidelink channel which may include an indication of CSI-RS presence, an indication of CSI reporting triggering, and/or a subchannel within which a CSI-RS is transmitted. The first type of CSI-RS may be referred to as measurement CSI-RS (M-CSI-RS).

A second type of CSI-RS may be a reference signal transmitted for CSI measurement and present always within a PSSCH resource irrespective of CSI feedback is enabled or disabled. The second type of CSI-RS may be used as a DM-RS for another sidelink channel (for example, a PSCCH or a PSSCH). The second type of CSI-RS may be referred to as DM-RS when it is not used for CSI measurement. A time density of the second type of CSI-RS may be configurable or determined based on one or more transmission parameters of a sidelink channel (for example, a PSSCH or a PSCCH), wherein the transmission parameter(s) may include at least one of a modulation and coding scheme (MCS), transport block size, QoS, or cast type.

A third type of CSI-RS may be used or present when an operating frequency band is higher than a threshold. For example, the third type of CSI-RS may be used when the operating frequency band is higher than 6 GHz. Otherwise, another type of CSI-RS may be used. The third type of CSI-RS may be referred to as phase-tracking reference signal (PT-RS).

A CSI-RS location may be determined based on an operating frequency. For example, when the operating frequency is lower than a threshold (for example, 6 GHz), an associated CSI-RS may be transmitted in a PSSCH resource which may be scheduled by PSCCH, wherein an SCI may trigger CSI reporting or indicate the presence of CSI-RS. Further, when the operating frequency is higher than a threshold (for example, 6 GHz), an associated CSI-RS may be transmitted in a PSSCH resource which may be reserved by a PSCCH, wherein an SCI may trigger CSI reporting or indicate the presence of CSI-RS.

Examples of a determination of CSI-RS types are provided herein. In an example, one or more of S-CSI-RS types may be used when a WTRU triggers sidelink CSI feedback and a CSI-RS type may be used for a sidelink CSI measurement. For example, a transmitting WTRU may determine which CSI-RS type may be used for CSI reporting triggering. The CSI-RS type may be determined based on one or more of the below embodiments. Further, a receiving WTRU may determine which CSI-RS type may be used to measure CSI based on one or more of following embodiments.

In an embodiment, a type of CSI-RS for CSI measurement may be determined based on at least one of the following parameters: a maximum rank, a slot index, a subchannel index, a channel busy ratio (CBR), a QoS, a minimum communication range (MCR), a mobile speed, an indication in SCI, and a DM-RS density of PSSCH. In an example, a determination of CSI measurement may be performed between the first type of CSI-RS and the second type of CSI-RS. That is, in an embodiment, either the first type of CSI-RS or the second type of CSI-RS may be determined and thus used for CSI measurement. Some of the above-mentioned parameters for determining a type of CSI-RS will be described in detail below.

For example, if a maximum rank is less than a threshold for a CSI feedback and/or a sidelink transmission, the second type of CSI-RS (for example, a DM-RS of a PSSCH) may be used. Otherwise, the first type of CSI-RS (for example, an M-CSI-RS) may be used. In an example, the threshold may be 2. Therefore, for example, if the maximum rank is 1 for a unicast, the DM-RS of the PSSCH may be used for CSI measurement. Otherwise, M-CSI-RS may be used.

In another example, a slot index may involve a slot for RLM or RRM measurement. The first type of CSI-RS (for example, an M-CSI-RS) may be used if the CSI-RS is transmitted in a slot wherein a WTRU may need to measure RLM or RRM. Otherwise, the second type of CSI-RS (for example, a DM-RS of a PSSCH) may be used.

In a further example, a subchannel index may be used. For example, one or more of subchannels within a resource pool may be configured for a specific purpose. The purpose may include, for example, a physical sidelink feedback channel (PSFCH) transmission. The second type of CSI-RS may be used for those subchannels, otherwise the first type of CSI-RS may be used. For example, a DM-RS of a PSSCH may be used for CSI measurement when a subchannel includes a PSFCH resource.

In an additional example, if CBR is higher than a threshold, the second type of CSI-RS may be used. Otherwise, the first type of CSI-RS may be used for CSI measurement. For example, the threshold may be 40%.

Also, if a QoS of unicast link is higher than a threshold, the first type of CSI-RS may be used. Otherwise, the second type of CSI-RS may be used for CSI measurement. For example, the threshold may be associated with a quantized value between 1 and 8 (3 bits). For example, the QoS may be the worst case of QoS or the best cast of QoS.

In an example involving MCR, if a receiving WTRU is in-MCR, the first type of CSI-RS may be used. Otherwise, the second type of CSI-RS may be used.

In an example involving mobile speed, if a relative speed or a WTRU speed is higher than a threshold, the second type of CSI-RS may be used. Otherwise, the first type of CSI-RS may be used. For example, the threshold may be XXXX.

In an example involving an indication in SCI, a WTRU may indicate which type of CSI-RS is used for CSI feedback in an associated SCI when the WTRU triggers CSI feedback. In an example, the indication may be explicit. In another example, the indication may be implicit.

In yet another example, if a DM-RS density of a PSSCH is higher than a threshold, the second type of CSI-RS may be used. Otherwise, the first type of CSI-RS may be used. For example, the threshold may be XXXX.

A maximum rank indicator (RI) value may be limited based on the number of antenna ports used for the second type of CSI-RS. The number of antenna port may be determined based on the transmission rank of a sidelink channel (for example, a PSSCH or a PSCCH) for the second type of CSI-RS. That is to say, the maximum RI value may be limited based on the transmission rank of a sidelink channel when the second type of CSI-RS is used.

Based on the type of CSI-RS used, the resource elements (REs) rate-matched around for a PSSCH may be different. For example, when the first type of CSI-RS is used, one or more of PSSCH REs, which may overlap with the first type of CSI-RS, may be rate-matched around. Further, when the second type of CSI-RS is used, no PSSCH REs may be rate-matched around due to the CSI-RS. Also, puncturing may be used instead of rate-matching of PSSCH REs. For a punctured PSSCH RE, a WTRU may send a zero-energy signal on the RE or may not send any signal on the RE. For a rate-matched PSSCH RE, a WTRU may not consider the RE as an available RE for PSSCH transmission. Further, a transmitting/receiving WTRU may know which REs may be punctured or rate-matched around based on which type of S-CSI-RS may be used.

The determination, selection or both between rate-matched PSSCH REs and punctured PSSCH REs may also depend on the data QoS. For example, for data with higher reliability requirements, the rate-matched PSSCH REs may be applied. Otherwise, the punctured PSSCH REs may be applied. The determination, selection or both between rate-matched PSSCH REs and punctured PSSCH REs may be jointly dependent on data QoS and the type of S-SCI-RS used.

Sidelink CSI reporting is first described. In some examples, a WTRU may trigger, activate, or deactivate a sidelink CSI reporting to determine a sidelink channel quality. The triggering of sidelink CSI reporting may include one or more of following embodiments.

A transmitting WTRU may request to report/feedback a measurement of sidelink reference signal transmitted from the transmitting WTRU, wherein the measurement may include at least one of CSI, RSRP, reference signal received quality (RSRQ), received signal strength indicator (RSSI), or beam quality. In some examples, the CSI may include one or more of CQI, PMI, or RI. Further, the request may be received by a receiving WTRU, wherein the receiving WTRU may be a WTRU in a sidelink communication, for example, in unicast or groupcast.

Also, a transmitting WTRU may send a measurement RS which may be at least one of CSI-RS, beam measurement reference signal (BM-RS), demodulation reference signal (DM-RS) of PSCCH and/or PSSCH, phase tracking reference signal (PT-RS), radio link modulation reference signal (RLM-RS), or radio resource management reference signal (RRM-RS). The measurement RS may be transmitted in a PSSCH resource, wherein the measurement RS may be transmitted when a transmitting WTRU has a sidelink data to send.

Further, the time/frequency location of the measurement RS within an associated PSSCH resource may be indicated in the associated PSCCH, wherein the PSSCH resource may be one or more subchannels within a resource pool. The measurement RS may be transmitted in a subset of subchannels if the associated PSSCH occupies more than one subchannel. The subchannel location may be predefined (for example, first subchannel, middle subchannel, or last subchannel). Further, the subchannel location may be determined based on one or more of the following parameters: identity, QoS, CBR, MCR, and an in-coverage or out-of-coverage determination. In examples, the identity may be a source-id, a destination-id or both. Also, the subchannel location may be configured via PC5-radio resource control (RRC).

In addition, a transmitting WTRU may send an indication of triggering sidelink CSI reporting, wherein the indication may be at least one of the following parameters: a bit field in the associated SCI, a source=id, or a slot number or index. These parameters will be described in detail below.

In an example including a bit field in the associated SCI, the bit field may indicate one or more of the following: presence of measurement RS, time/frequency location of the measurement RS, transmission power level (or ratio) of the measurement RS, periodic reporting or aperiodic reporting.

In an example, a receiving WTRU may receive an SCI from a source-id which may be preconfigured, or predetermined. The receiving WTRU may measure sidelink CSI and report. One or more of source-id may be used from a transmitting WTRU. Further, a first source-id may represent no sidelink CSI trigger (for example, no measurement RS is present) and a second source-id may represent sidelink CSI trigger (for example, measurement RS is present). Also, a source-id may be used interchangeably with a destination-id and may still be consistent with the examples and embodiments provided herein. In an example including a slot number or index, if a receiving WTRU received an SCI in a specific slot, the receiving WTRU may measure sidelink CSI and report.

In an example, a transmitting WTRU may be triggered to transmit a CSI-RS (and/or CSI reporting) within a PSSCH transmission when one or more of following thirteen conditions are met.

First, resource-selection may be triggered by higher layers.

Second, CBR may be higher than a threshold or lower than a threshold.

Third, a HARQ NACK may have been received. HARQ-NACK may be received N consecutive times from a same WTRU, wherein N may be configured, predefined, or indicated.

Fourth, a timer may have expired. For example, a WTRU may set a timer with a start at the last received CSI reporting and the timer value may be based on the transport block (TB) QoS requirement (for example, reliability and latency), estimated channel condition (for example coherent time of the channel) and/or WTRU speed.

Fifth, the QoS requirement of the TB may have changed. For example, reliability requirement of the TB may have changed. The worst case of the QoS requirement may be changed, wherein the worst case of QoS may be a QoS requiring one or more of the following: the shortest latency, the highest reliability, the largest range, the highest data rate, and the largest packet size.

Sixth, the transmission parameters and/or scheme may change. For example, the number of ranks may change.

Seventh, the size of TB may have changed.

Eighth, the received RSRP and estimated PL may have changed.

Ninth, the WTRU transmitting-receiving distance may have changed. For example, a transmitting WTRU may request a CSI reporting when transmitting-receiving distance may exceed a threshold.

Tenth, a new unicast (or groupcast) link may be established.

Eleventh, zone-id of the transmitting WTRU and/or the receiving WTRU may be changed.

Twelfth, DTX of a sidelink transmission may be received. For example, after a sidelink transmission, the transmitting WTRU may receive a DTX in the associated HARQ resource, and the transmitting WTRU may be triggered to transmit a CSI-RS and its associated CSI reporting.

Thirteenth, a CSI-RS request indication may be received from a receiving WTRU. This CSI-RS request indication may be a RRC message, a MAC control element (CE) or may be contained in SCI. The receiving WTRU may send the CSI-RS request indication under one or more of the following triggering conditions: (1) N consecutive PSCCH and/or PSSCH decoding errors; (2) a change of WTRU transmitting-receiving distance, or (3) a change of the zone-id of the receiving WTRU.

In another embodiment, a WTRU may not be allowed to trigger sidelink CSI reporting when one or more of following ten conditions are met.

First, a CBR may be higher than (or lower than) a threshold, wherein the threshold may be determined based on one or more of following parameters: a QoS (or the worst case of QoS), a transmitting-receiving distance, in-MCR (for example, transmitting-receiving distance is within a minimum required communication range) or out-MCR (for example, transmitting-receiving distance is outside a minimum required communication range), or in-coverage or out-of-coverage.

Second, HARQ-ACK may be received for the latest sidelink transmission. Alternatively, a consecutive N HARQ-ACK may be received for the previously transmitted sidelink transmissions.

Third, received power of HARQ-ACK may be higher than a threshold.

Fourth, measured RSRP from a reference signal transmitted from a receiving WTRU may be higher than a threshold.

Fifth, a transmitting Beam may be the same from the latest sidelink transmission (of which HARQ-ACK received). The transmitting beam may be referred to as an indication of a reference signal index used for quasi-collocation type D indication or transmit channel indication (TCI) state.

Sixth, a QoS is lower than a threshold. For example, this condition may include one or more of following: (1) minimum communication range is lower than a threshold; (2) reliability is lower than a threshold; (3) priority is lower than a threshold; (4) data rate is lower than a threshold; (5) packet size is smaller than a threshold.

Seventh, the transmitting WTRU (and/or receiving WTRU) may be out-of-coverage (or in-coverage).

Eighth, a configuration may indicate that no sidelink CSI feedback may be allowed. The configuration may be at least one of the following: a higher layer configuration from network, a resource pool configuration, a unicast configuration via PC5-RRC between two unicast WTRU, or a groupcast configuration.

Ninth, a transmitting WTRU may receive an out-of-range indication from a receiving WTRU. Further, a CQI table may include a CQI field indicating out-of-range and the CQI field may be used when: there is no other CQI values applicable for current channel condition; the receiving WTRU is out-MCR; and/or the current channel condition cannot meet QoS of a packet.

Tenth, a transmitting WTRU received N consecutive DTX of sidelink transmissions, wherein N may be non-negative integer.

Sidelink CSI reporting depending upon one or more measurement RSs will be described below. The CSI reporting may be sent in a MAC CE or in physical layer signaling, for example, similar to UCI on a PUSCH in an NR Uu link. It may be possible to support both MAC CE based and physical layer signaling based CSI reporting. The selection between these two schemes may depend on one or more of the following two conditions. The first condition is related to CSI-RS type. For example, MAC CE based reporting may be used when the first type of CSI-RS is used for the CSI measurement, while physical layer signaling based CSI reporting may be used when the second type of CSI-RS is used for the CSI measurement. The second condition is related to a (pre-)configuration. CSI reporting may be part of the configuration in the link establishment, or may be part of the resource pool configuration. In examples, the configuration may be performed through a preconfiguration.

Examples provided herein may include a dynamic sidelink CSI-RS indication. For example, a transmitting WTRU may indicate the presence of the CSI-RS transmission in the SCI. A WTRU may be configured with a set of CSI-RS pattern(s) for a resource pool and the SCI indication may be an index to the configured set. In an example, the WTRU may be preconfigured with the set of CSI-RS pattern(s). The CSI-RS pattern may be for example defined on a sub-channel-basis and the transmitting WTRU may indicate in the SCI one or more of the following: CSI-RS in each sub-channel used by PSSCH, CSI-RS in the sub-channel used by PSCCH, or CSI-RS in a sub-set of the sub-channels used by PSSCH.

In one example, a transmitting WTRU may indicate in the SCI the QoS requirement associated with CSI-RS transmission (and/or CSI reporting), wherein the QoS requirement may include one or more of following requirements.

First, the QoS requirement of the PSSCH transmission which the CSI reporting may apply to. A latency requirement of the QoS may determine the reporting timing of the triggered CSI feedback.

Second, the CSI-RS may be transmitted within a PSCCH and its associated PSCCH (for example, in SCI) may indicate the presence of CSI-RS and/or triggering of CSI reporting, and the SCI may indicate QoS of its associated PSSCH. The QoS of CSI-RS (and/or CSI reporting) may be determined based on the QoS of PSSCH transmitted together in the slot.

Third, the QoS associated with CSI-RS (and/or CSI reporting) may be indicated separately from the QoS associated with a PSSCH. For example, one or more QoS indications may be in a SCI and the first QoS indication may be associated with a PSSCH and the second QoS indication may be associated with a CSI reporting. Further, the number of bits for the first QoS and the second QoS may be different. For example, QoS parameters used for the second QoS may be a subset of QoS parameters used for the first QoS. For example, the first QoS may include one or more of the following QoS parameters: payload (Bytes), transmission rate (Message/Sec), maximum end-to-end latency (ms), reliability (%), data rate (Mbps), or minimum required communication range (meters). The second QoS may include the subset of the above-mentioned QoS parameters For example, the second QoS may include: maximum end-to-end latency (ms); reliability (%); minimum required communication range (meters).

Further, the QoS associated with CSI-RS (and/or CSI reporting) may be a subset of QoS parameters associated with a PSSCH. For example, a receiving WTRU may use only a subset of QoS parameters of the QoS associated with the PSSCH.

In another example, a transmitting WTRU may be configured with a CSI-RS density and/or a resource configuration based on the QoS requirement and the receiving WTRU may determine the QoS requirement associated with the CSI-RS transmission accordingly. In an example, the WTRU may be preconfigured with the CSI-RS density and/or the resource configuration. Also, the CSI-RS QoS requirement may be configured to be the same as that of the accompanying PSSCH transmission. In an example, the CSI-RS QoS requirement may be preconfigured.

In embodiments, a WTRU may make resource selection, resource reselection or both for CSI report transmissions. Alternatively or additionally, the WTRU may make resource selection, resource reselection or both for CSI-RS transmissions. A transmitting WTRU may transmit CSI-RS to a receiving WTRU and trigger a measurement of CSI-RS transmission. Once the associated measurement of CSI-RS transmission has been performed by the receiving WTRU, it will transmit CSI report to the transmitting WTRU. A MAC layer of the WTRU may receive the CSI report from its PHY layer. The transmitting WTRU may perform resource selection, resource reselection or both based on the timing of reception of CSI feedback/CSI report from lower layers.

In one embodiment, a WTRU may trigger resource selection to reserve sidelink resources under the condition that the WTRU does not have any pending SL grants for sidelink transmission to use to transmit the CSI-RS MAC CE. In another embodiment, a WTRU may trigger resource selection, resource reselection or both if the WTRU has one or more pending SL grants, but the grants do not meet specific criteria associated with the CSI-RS report, such as in the following examples.

In one embodiment, a WTRU may trigger an SL-buffer status report (BSR) under the condition that the WTRU does not have pending grants for sidelink transmission to use to transmit the CSI-RS MAC CE. In another embodiment, a WTRU may trigger an SL-BSR if the UE has one or more pending SL grants, but the grants do not meet specific criteria associated with the CSI-RS report, such as in the following examples.

In an example, the one or more pending grants may not occur within a time window or required latency associated with the CSI-RS report. Such a window may be determined based on mechanisms defined in this disclosure.

In a further example, the one or more pending grants may not be used for transmission of the CSI-RS report, based on some restriction such as in the following examples. In one example, the logical channel associated with the MAC CE transmission cannot be transmitted onto the grant due to a restriction associated with the logical channel. In another example, the determined priority of the MAC CE, based on methods for priority determination described in this disclosure, may be such that the MAC CE cannot be transmitted onto the grant due to a restriction associated with the logical channel. In a further example, the grant may be associated with a destination identity (ID) which does not match the destination to which the CSI-RS report should be sent.

Further, a WTRU which performs resource selection, resource reselection or both associated with a pending MAC CE may provide the physical (PHY) layer with QoS information to be used for performance of resource selection. In an example, the QoS information may include priority information.

In an example, the WTRU may determine the priority information by first deriving an L2 priority associated with the MAC CE. The MAC CE may then be treated similarly to any pending data for which resource selection has been triggered and QoS information needs to be provided to the PHY layer for the resource selection. Specifically, the WTRU MAC may derive an L1 priority from the derived L2 priority, for example, based on preconfiguration, and may provide such L1 priority to the lower layers. The PHY layer may select a resource selection window, for example, a value of T2, on which to perform resource selection based on the provided L1 priority. The L2 priority associated with the MAC CE may be derived using any of the methods described in this disclosure for determining the L2 priority for a logical channel prioritization (LCP) procedure.

In another example, the WTRU may first derive an L2 priority associated with the MAC CE based on the CSI feedback reporting window associated with the CSI feedback, which may be determined as described in this disclosure. Specifically, the WTRU may first determine a CSI feedback window using methods described in this disclosure. The WTRU may then determine which of the one or more logical channels the WTRU has configured was configured with a QoS flow with a similar latency requirement. In an example, the latency requirement may be expressed in term of PC5 5G QoS characteristics (5QI) (PQI). Specifically, the WTRU may select a logical channel (LCH) for which the mapped QoS flow had a latency requirement that is smaller than or equal to the latency associated with the CSI-feedback required latency, latency window or both. Alternatively, the WTRU may select a LCH for which the mapped QoS flow had the closest latency to the CSI-feedback required latency, latency window or both.

In another example, the WTRU may first derive an L2 priority associated with the MAC CE based on the CSI feedback reporting window associated with the CSI feedback, as determined in examples described in this disclosure. In such an example, the WTRU may first determine the CSI feedback window using methods described in this disclosure. The WTRU may then determine the L2 priority which is associated with such a window. Specifically, the WTRU may select an L2 priority for which the latency corresponding to the L2 priority is smaller than or equal to the CSI feedback window latency. The WTRU may then provide such priority to the lower layers for resource selection, resource reselection or both. The WTRU may apply such priority in the resource selection performed at the lower layers, the resource reselection procedure performed at the lower layers or both.

In a further example, the WTRU may provide its PHY layer with the CSI feedback reporting window latency or latency bound. The CSI feedback reporting latency or latency bound may be in the form of a remaining packet delay budget (PDB) of the data to be transmitted which triggered the resource selection. The WTRU may apply the CSI feedback reporting window latency or latency bound. The CSI feedback reporting window latency or latency bound may be in the form of a remaining PDB of a TB which is to be transmitted in a resource selection procedure performed at the PHY layer, a resource reselection procedure performed at the PHY layer or both, and to be triggered by the TB. Specifically, the WTRU may determine the remaining PDB to be used in resource selection based on the CSI latency bound or CSI feedback window. The WTRU may determine the remaining PDB as the remaining latency until the CSI latency bound or CSI feedback window. The remaining PDB provided to the PHY layer may represent the configured CSI feedback reporting window latency or latency bound. Alternatively or additionally, the WTRU may determine the PDB as the closest PDB associated with any data logical channel, such that the determined PDB is less than the CSI feedback reporting window latency or latency bound. The PHY layer may provide a set of resources to the MAC layer which meet the remaining PDB, so that the MAC layer may select from these resources for transmission of the CSI feedback MAC CE. In an example, the MAC layer may make the selection randomly.

In another example, the WTRU may indicate to the PHY layer that the resource reselection is associated with transmission of a CSI feedback MAC CE. The MAC layer may further provide the window to the PHY layer, or the MAC layer may indicate to the PHY layer the specific destination address or identifier of the MAC CE which triggered the reselection so that the PHY layer may select resources based on the window.

In some embodiments, a WTRU may determine the L2 source, L2 destination or both for a CSI report MAC CE. The WTRU may receive a CSI-RS report from its PHY layer, and may have multiple unicast links ongoing. During MAC layer multiplexing, the WTRU may determine the L2 destination ID to which a specific MAC CE is to be transmitted. For this reason, the WTRU needs to be able to associate the CSI-RS report received from the lower layers with the specific unicast link to which that report is intended.

In an example, a WTRU may receive the CSI-RS report from lower layers along with a decoded MAC PDU. The WTRU may determine the unicast link to which the CSI-RS report is to be sent, for example, using the L2 source/destination ID of the CSI-RS report, by determining the L2 destination/source ID in the decoded MAC PDU that is sent along with the CSI-RS report. Specifically, the L2 destination address of the CSI-RS report may comprise the L2 source ID of the decoding MAC PDU, and the L2 source ID of the CSI-RS report may comprise the L2 destination ID of the decoded MAC PDU.

In another example, a WTRU may drop a CSI-RS report if the WTRU, or the MAC layer of the WTRU, is unable to decode the MAC PDU. The WTRU may be unable to decode the MAC PDU because the WTRU is, for example, unable to determine the L2 source/destination ID, or unable to find a unicast link having the associated L2 source/destination ID indicated in the MAC PDU.

In examples, an LCP procedure may consider a CSI-RS feedback MAC CE. The WTRU may consider the presence of a MAC CE in the sidelink LCP procedure. In an example, the WTRU may prioritize selection of destination address based on destination addresses having one or more pending MAC CEs for transmission.

In a further example, the WTRU may assign a latency value or latency bound value to the SL CSI MAC CE. Such a value may be determined by procedures in any related example described in this disclosure.

In another example, the WTRU may assign an L2 priority to the SL CSI-RS feedback MAC CE. The WTRU may perform SL LCP by selecting the destination address having the highest priority data or MAC CE to transmit. The L2 priority of the MAC CE carrying the SL CSI report may be determined based on one or more of the following priorities: a preconfigured priority, the priority of the received data, or the priority of the LCHs associated with transmissions to a peer WTRU. Accordingly, the WTRU may assign a priority to a CSI feedback transmission. In an example, the CSI feedback transmission may be used for resource selection. Some of the above-mentioned priorities will be further described below.

In an embodiment, the L2 priority of the MAC CE carrying the SL CSI report may be determined based on a preconfigured priority. In one example, the WTRU may consider an SL MAC CE to have the highest/lowest priority compared to other SL LCHs. In another example, the network may configure the L2 priority associated with SL MAC CE in system information block (SIB)/dedicated signaling/out-of-coverage (00C) preconfiguration.

In an embodiment, the L2 priority of the MAC CE carrying the SL CSI report may be determined based on the priority of the received data. In one example, the WTRU may consider an SL MAC CE to have a priority that is the same as or derived from the priority of the peer WTRU transmission for which the SL-CSI was measured. For example, the WTRU may derive the L2 priority of the MAC CE from the L1 priority received in the transmission carrying the CSI-RS that was measured. The mapping of L2 priority to L1 priority may be configured at the WTRU or preconfigured at the WTRU. In another example, the WTRU may derive the L2 priority from the LCH.

In an embodiment, the L2 priority of the MAC CE carrying the SL CSI report may be determined based on the priority of the LCHs associated with transmissions to the peer WTRU. In one example, the WTRU may determine the L2 priority of the SL MAC CE based on the LCHs configured at the WTRU for transmission to the destination WTRU to which CSI-RS MAC CE needs to be transmitted. For example, the WTRU may determine the L2 priority of the MAC CE to be the highest/lowest L2 priority associated with any configured LCHs at the WTRU which have the same destination address as the intended destination of the MAC CE.

Examples involving CSI-RS transmission dropping are provided herein. A WTRU may drop a CSI-RS transmission based on one or both of the following conditions.

First, a WTRU may drop a CSI-RS transmission if a CBR is above a threshold. For example, the WTRU may be configured with a CBR threshold for the SL resource pool on which the CSI-RS report should be transmitted. If the CBR is above the CBR threshold, the WTRU may drop the transmission of CSI-RS report.

Second, a WTRU may drop a CSI-RS transmission if a timer expires. In other words, a WTRU may drop a CSI-RS transmission based on an expiry of a timer. For example, the WTRU may start a timer at the reception of CSI-RS report from the PHY layer. Upon expiry of the timer, the MAC layer may drop the CSI-RS report MAC CE which is pending and not yet transmitted. The value of the timer may be set based on mechanisms similar to those described in this disclosure for setting of the reporting window.

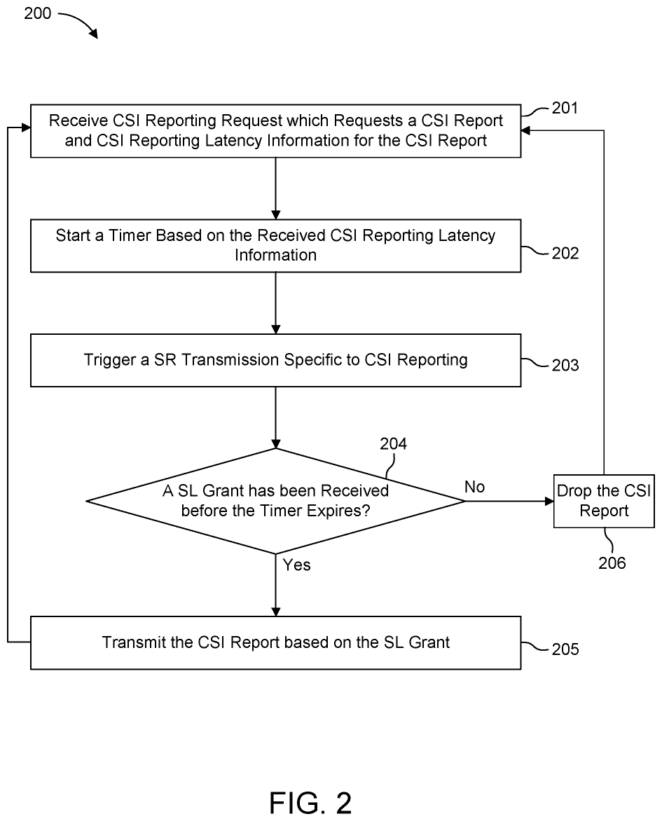

A method 200 according to an embodiment of this disclosure is described below with reference to FIG. 2. FIG. 2 is a flow chart illustrating the method 200. The method 200 may be used by a WTRU (e.g., a receiving WTRU) which is able to communicate with a network or another WTRU (e.g., a transmitting WTRU) through SL. The WTRU is configured with a set of SR configurations, In this disclosure, unless otherwise indicated, the WTRU performing the method 200 may be referred to as the receiving WTRU. A WTRU, which transmits signals (e.g., CSI-RS, data, etc.) to the receiving WTRU, may be referred to as the transmitting WTRU, the network, or the base station. In this disclosure, unless otherwise indicated, the terms “transmitting WTRU”, “base station” and “network” may be used interchangeably. A WTRU, which receives CSI-RS, SL grant and other signals from the network, may be referred to as the receiving WTRU.

The method 200 may comprise: at 201, receiving, through the SL, (1) CSI reporting request which requests a CSI report and (2) CSI reporting latency information for the CSI report; at 202, starting a timer based on the received CSI reporting latency information; at 203, triggering a SR transmission specific to CSI reporting; and at 204, determining if a SL grant has been received before the timer expires. On a condition that the SL grant has been received before the timer expires, the method 200 may further comprise: at 205, transmitting the CSI report based on the SL grant. And on a condition that no SL grant has been received before the timer expires, the method 200 may further comprise: at 206, dropping the CSI report. The above-mentioned different processes from 201 to 206 will be further described below with reference to detail embodiments.

Accordingly, the WTRU may be able to communicate with a network through sidelink (SL) and the WTRU is configured with a set of scheduling request (SR) configurations. Further, the WTRU comprises a transceiver and a processor. The transceiver is configured to receive, through the SL, (1) CSI reporting request which requests a CSI report and (2) CSI reporting latency information for the CSI report. The processor is configured to start a timer based on the received CSI reporting latency information; trigger a SR transmission specific to CSI reporting; and determine if a SL grant has been received before the time expires. On a condition that a SL grant is received before the timer expires, the processor is further configured to transmit, through the transceiver, the CSI report based on the SL grant. And on a condition that no SL grant is received before the timer expires, the processor is further configured to drop the CSI report. It should be noted that the WTRU may also comprise additional components, such as memory, circuit, battery, etc. It is assumed that those additional components are widely known and thus a detail description of the additional components will be omitted from this disclosure. The WTRU as well as its transceiver and processor will be further described below with reference to detail embodiments.

At 201, the method 200 may comprise: receiving, through the SL, (1) CSI reporting request which requests a CSI report and (2) CSI reporting latency information for the CSI report. The process at 201 may be performed by the receiving WTRU.

The transmitting WTRU may transmit a CSI-RS to the receiving WTRU and request to report/feedback a measurement of CSI-RS transmitted from the transmitting WTRU. In an example, the transmitting WTRU may transmit a CSI reporting request with the CSI-RS. In another example, the CSI reporting request may be an indication which is a RRC message or a MAC CE. In still another example, the CSI reporting request may be contained or indicated in SCI. It should be appreciated that although some examples of the CSI reporting request have been discussed above, they are not intended to be exclusive or be limiting to the CSI reporting request disclosed in this disclosure. Other kinds of CSI reporting request may be available as long as they may help to realize the principle of this disclosure.

In an example, the CSI reporting latency information for the CSI report may be provided from the network or the transmitting WTRU (e.g. via PC5 RRC signaling). In an example, the CSI reporting latency information for the CSI report may be pre-configured in the receiving WTRU. In an example, the CSI reporting latency information may also be determined based on one or more of following parameters: one or more of QoS parameters, CBR, MCR (e.g., In-MCR or out-MCR), coverage (e.g., In-coverage or out-of-coverage), Mode (Mode-1 or Mode-2), cast type (e.g., groupcast or unicast), maximum rank, or mobile speed (or relative speed between two WTRUs). In an example, the CSI reporting latency information may be received through MAC CE/RRC signaling. It should be noted that the above example are not intended to be exclusive or be limiting to the CSI reporting latency information. The CSI reporting latency information may be generated/determined by any other available methods as long as the CSI reporting latency information may help to realize the principle of this disclosure.

In an example, the CSI reporting latency information may be a set of information which includes CSI reporting latency or CSI reporting latency bound. The latency/latency bound is the same as or similar to those discussed above in this disclosure. The latency/latency bound will be further described below with reference to detailed examples. It should be noted that the latency/latency bound/latency information is directed to a latency value. Therefore, in this disclosure, unless otherwise indicated, the terms of “latency”, “latency value”, “latency bound”, “latency bound value”, “window”, “latency window” and “latency information” may be used interchangeably.

Then the method 200 may proceed to 202. At 202, the method 200 may comprise: starting a timer based on the received CSI reporting latency information. In an example, the receiving WTRU may start a timer with a start point when the CSI reporting request is received. In an example, the timer value may be based on the latency/latency bound in the CSI reporting latency information. The timer may be implemented through the processor using a software, an algorithm, etc. It should be noted that the above example are not intended to be exclusive or be limiting to the timer disclosed in this disclosure.

Then the method 200 may proceed to 203. At 203, the method 200 may comprise: triggering a SR transmission specific to CSI reporting. The SR transmission may be a transmission from the receiving WTRU to the transmitting WTRU (which sent CSI-RS to the receiving WTRU). The SR transmission specific to CSI reporting may indicate that the receiving WTRU wants to do CSI reporting and thus trigger the transmitting WTUR or the network to determine/allocate sidelink resources for the CSI reporting.

The process at 203 may further comprise: selecting a SR configuration from the set of SR configurations based on the received CSI reporting latency information; and transmitting a SR to the network/the base station based on the SR configuration. In an example, the set of SR configurations may comprise multiple SR configurations, and the WTRU may select a desired SR configuration from the multiple SR configurations based on the CSI reporting latency information received at 201. For example, an SR configuration may indicate PUCCH resource(s) for SR transmission. An SR configuration may also comprise other parameters, such as timing, slot, frequency, etc. It should be noted that the above parameters regarding the SR configuration is not intended to be exclusive or be limiting to the SR configuration. After the SR configuration is selected/determined, the receiving WTRU may transmit a SR to the transmitting WTRU (which sent the CSI-RS to the receiving WTRU) or the network based on the SR configuration.

In an example, each of the set of SR configurations is associated with pre-configured CSI reporting latency information from a pre-configured CSI reporting latency information set. The pre-configured CSI reporting latency information set may comprise multiple pre-configured CSI reporting latency information. Generally, the pre-configured CSI reporting latency information may be similar to the above-discussed CSI reporting latency information for the CSI report. For example, the pre-configured CSI reporting latency information also be determined based on one or more of following parameters: one or more of QoS parameters, CBR, MCR (e.g., In-MCR or out-MCR), coverage (e.g., In-coverage or out-of-coverage), Mode (Mode-1 or Mode-2), cast type (e.g., groupcast or unicast), maximum rank, or mobile speed (or relative speed between two WTRUs). The pre-configured CSI reporting latency information may be pre-configured by the receiving WTRU, the transmitting WTRU or the network. For example, the pre-configure CIS reporting latency information may be pre-configured or predetermined by the transmitting WTRU and then the transmitting WTRU may transmit the pre-configured CSI reporting latency information to the receiving WTRU.

The pre-configured CSI reporting latency information may comprise a CSI reporting latency (e.g., 10 ms, 20 ms, etc.) or a CSI reporting latency bound. In an example, one pre-configured CSI reporting latency information may only comprise one CSI reporting latency (or latency bound). In the pre-configured CSI reporting latency information set, there are two pre-configured CSI reporting latency information, i.e., two CSI reporting latency (i.e., one is 10 ms, and another is 20 ms). Meanwhile, the set of SR configurations comprises two SR configurations (i.e., the first SR configuration and the second SR configuration). In that case, the first SR configuration may be associated with the CSI reporting latency which is 10 ms, while the second SR configuration may be associated with the CSI reporting latency which is 20 ms. It should be noted that the above example regarding the SR configurations and the pre-configuration CSI reporting latency information set are not intended to be exclusive or be limiting to the present disclosure.

In an example, the WTRU may be configured with a mapping of the set of SR configurations to the pre-configured CSI reporting latency information set. The mapping may indicate the relationship between a SR configuration and a pre-configured CSI reporting latency in the pre-configured CSI reporting latency information. In an example, multiple SR configuration may be mapped to one pre-configured CSI reporting latency. In that case, the receiving WTRU may select SR configuration in the multiple SR configurations for CSI reporting based on the SR configurations' priority. In an example, the mapping may be pre-configured by the receiving WTRU. In another example, the mapping may be provided from the base station. It should be noted that the above description about the mapping is only given by way of example, and they are not intended to be exclusive or be limiting to the present disclosure.

In an embodiment, the method 200 my further comprise: providing a computed latency for the CSI report to the network or to the transmitting WTRU. In an example, the computed latency may be the current latency that the receiving WTRU has for CSI reporting. In an example, the computed latency may be a desired latency that the receiving WTRU may want to have for CSI reporting. The computed latency may be the same or similar to the CSI reporting latency discussed above. For example, the computed latency may be 10 ms, 20 ms, etc. The computed latency may be determined/computed in a similar way to those used for determining the pre-configured CSI reporting latency. It should be noted that the above examples of the computed latency are not intended to be exclusive or be limiting to the present disclosure.

Then the method 200 may proceed to 204. At 204, the method 200 may comprise: determining if a SL grant has been received before the time expires. For example, once the base station receives the SR transmission, it may determine and allocate resources to the receiving WTRU, and then transmit to the receiving WTRU a SL grant which may indicate that the receiving WTRU may transmit a CSI report to the base station. The SL grant may also indicate parameters for CSI report transmission. In a scenario, the receiving WTRU may receive a SL grant before the timer expires, while in another scenario, the receiving WTRU may not receive any SL grant before the timer expires. Different processes may be performed by the processor based on the outcome of the process at 204. The following description will further describe the processes following the process at 204 below.

If at 204, the processor determines that a SL grant has been received before the timer expires, the method 200 may proceed to 205. At 205, the method 200 may further comprise: transmitting the CSI report based on the SL grant. In an example, the CSI report may be transmitted using a SL resource indicated in the SL grant. The SL grant may indicate parameters for CSI report transmission. Therefore, the processor may control to transmit a CSI report through the transceiver based on the SL grant.

If at 204, the processor determines that no SL grant has been received before the timer expires, the method 200 may proceed to 206. At 206, the method 200 may further comprise: dropping the CSI report. In that case, the receiving WTRU will not transmit a CSI report.

Examples involving an indication of SL-CSI reporting to the network are provided herein. A WTRU may indicate the presence of a pending SL-CSI report MAC CE to be transmitted in sidelink in order to receive sidelink grants from the network. In an example, the WTRU may receive sidelink grants in mode 1. In an example, a WTRU may trigger a report to the network when the MAC layer receives a CSI report to be transmitted to a peer WTRU. Specifically, a WTRU may trigger a scheduling request (SR) in the case where it does not have any SL grants. Further, a WTRU may trigger an SR in the case where the MAC layer receives a trigger to transmit a CSI report and all existing SL grants do not meet the latency requirements of the CSI report to be transmitted. A WTRU may be configured with a dedicated SR resource for indicating the presence of SL MAC CE to be transmitted. Alternatively or additionally, a WTRU may select from one of the configured SL-SR resources when it has a pending SL MAC CE to be transmitted. Specifically, the WTRU may select the SL-SR to trigger upon the presence of an SL-CSI report based on one or more of the following parameters: a predetermined mapping, a configuration by the network, the LCH or priority of the received transmission which triggered the SR transmission. Some of the above-mentioned parameters will be described in detail below.

In an example, the WTRU may select the SL-SR to trigger upon the presence of an SL-CSI report based on an explicit mapping, predetermined at the WTRU, of a SL MAC CE to one of the configured SL-SR resources.

In another example, the WTRU may select the SL-SR to trigger upon the presence of an SL-CSI report based on a configuration by the network. In an example, the configuration may be a preconfiguration. For example, the WTRU may be configured with an LCH to SR mapping where the LCH associated with the SL MAC CE is part of such mapping. In an example, the WTRU may be configured with a mapping of latency of a CSI report to an SR configuration. The WTRU may select the SR which is configured for the CSI report with a given latency requirement. For example, the WTRU may be provided with a range of latency values corresponding to each SR configuration, and may select the associated SR configuration when the latency falls within the latency range associated with that SR. For example, the WTRU may be configured with a finite number of latency values for the CSI report, and may select an SR configuration associated with each configuration. The latency of the CSI report may be determined by the WTRU based on any procedures described in examples in this disclosure. Accordingly, the WTRU may select an SR configuration for SR transmission based on the latency bound of the CSI report that triggered the SR.

The latency may be further provided from the peer WTRU. In an example, the latency may be provided via PC5 RRC signaling. The current latency may be maintained at the WTRU and changed with an event or periodically. For example, the current latency may be maintained at the WTRU and changed each time the WTRU receives a new value of the latency to use from the peer WTRU or the network. For example, the WTRU may periodically compute its latency value and maintain that computed latency value for the entire period. In an example, the entire period may last until the next calculation. For example, the WTRU may compute a new latency value when any of the factors affecting that value (e.g., speed) changes by a certain amount. The latency may be provided to the MAC layer by the PHY layer for use with SR triggering.

In a further example, the WTRU may select the SL-SR to trigger upon the presence of an SL-CSI report based on the LCH or priority of the received transmission which triggered the SR transmission. For example, a WTRU may determine the priority or LCH of the received transmission which triggered the SL-CSI report, and may select the SR of equivalent priority. In an example, the LCH may be the one whose L2 priority is the same as the priority in the received transmission for which SL CSI was measured.

A WTRU may trigger a BSR and may report the presence of a CSI report (for example a CSI report SL MAC CE) to be sent to the peer WTRU. For example, a WTRU may report intention of transmitting an SL MAC CE as part of the buffer status of a specific logical channel or logical channel group in the BSR. The SL MAC CE may be configured, preconfigured or predefined to some logical channel or logical channel group in sidelink.

In an example, a WTRU may report the intention of transmitting an SL MAC CE by transmitting an explicit indication in the BSR. In a further example, a WTRU may report the intention of transmitting an SL MAC CE by using a different BSR format.

The computed latency may be transmitted through the SR transmission or a control message. In an example, the computed latency may be transmitted as a part of the SR transmission. Therefore, when a WTRU receives the SR transmission, it will get the computed latency and use the computed latency to schedule sidelink resources for transmission of the CSI report.

For example, a WTRU may provide the computed CSI latency bound or window, as determined based on methods described in this disclosure, to the network. The computed CSI latency bound or window may help the network schedule sidelink resources for transmission of the CSI report. The WTRU may provide the computed CSI latency bound or window for the CSI report to the network implicitly, explicitly or both.

In an example, the WTRU may provide the computed CSI latency bound or window at the trigger of the CSI report. Specifically, the WTRU may indicate the computed CSI latency bound or the window each time the CSI report is triggered.

In an example, the WTRU may provide the computed CSI latency bound or window when the WTRU requests new resources from the network. Specifically, the WTRU may indicate the window or latency (or the latency bound) when it decides to request sidelink resources for transmission of the CSI report. For example, the value of the window or latency bound may be tied to the request for resources for transmitting the CSI request.

In a further example, the WTRU may provide the computed CSI latency bound or window periodically. For example, the WTRU may be configured with periodic reporting of the CSI window, and report the current computed window that is applicable at each periodic trigger.

In an additional example, the WTRU may provide the computed CSI latency bound or window when the current/applicable CSI window changes. For example, the WTRU may report the current computed window that is applicable when the value changes from the previously reported value, possibly by a certain amount.

A WTRU may report the window explicitly in a control message, such as an RRC message or a MAC CE. For example, the WTRU may report the CSI latency bound or window in the SidelinkUEInformation message upon initiation and/or reconfiguration of a unicast link between WTRUs. For example, the WTRU may report the CSI latency bound or window provided by the peer WTRU in PC5-RRC signaling during unicast link establishment.

A WTRU may report the window implicitly to the network by selection of an UL resource configured for each possible value of the configuration. For example, the WTRU may be configured with different PUCCH resources, or SR configurations, where each PUCCH resource, or SR configuration, is associated with a different latency. The WTRU selects the PUCCH resource, or SR configuration, that corresponds to the latency of the triggered CSI report of the current latency associated with the CSI report.

In additional examples, a WTRU may be configured with congestion-based transmission parameters specific to CSI report transmission. In an example, a WTRU may be configured with a specific set of congestion-based transmission parameters to be used for transmissions of CSI reports. In an example, the congestion based transmission parameters may be used for congestion control. Specifically, the WTRU may determine, for transmissions which contain CSI reports, to use a dedicated set of congestion-based transmission parameters configured specifically for such transmissions. Additionally or alternatively, the WTRU may associate the congestion-based parameters to be used for CSI report transmissions with one of the configurations for one of the logical channels.

For example, the WTRU may associate the congestion-based parameters with one of the configurations for the highest priority logical channel, the lowest priority logical channel or both. In one example, the WTRU may use the congestion-based parameters associated with the highest priority logical channel also for the transmissions containing CSI reports.

In another example, the WTRU may associate the congestion-based parameters with one of the configurations for the logical channel associated with the CSI report request. In one example, the WTRU may use the congestion-based parameters associated with the priority in the received SCI which also requested the CSI report.

Examples involving a wide-band CSI determination are provided herein. In an example, one PSSCH transmission bandwidth may be used for wide-band CSI. In an example, a transmitting WTRU may determine whether the resource reserved for the PSSCH transmission may provide a wide-band CSI based on the bandwidth of PSSCH transmission. For example, a transmitting WTRU may determine the PSSCH transmission resource to provide a wide-band CSI when: the number of sub-channels used for the PSSCH transmission may be above a threshold; and/or the number of sub-carriers used for the PSSCH transmission may be above a threshold. The threshold may be based on the total bandwidth of the applied resource pool and/or channel condition, for example estimated frequency selectivity.

Further, a transmitting WTRU may indicate a CSI request in the SCI associated with CSI-RS transmission. A receiving WTRU may send a CSI reporting corresponding to the CSI transmission. A transmitting WTRU, upon triggering CSI-RS transmission, may determine the accompanying PSSCH transmission parameters based on a previous CSI reporting, a (pre)configured CSI reporting, and/or a minimum CSI reporting.

In another example, a transmitting WTRU may adjust the received CSI and apply the adjusted CSI to the scheduled PSSCH transmission. For example, the adjustment may be an offset CQI value based on one or more of the following parameters: (1) the frequency difference between the sub-channels of the CSI-RS transmissions and the sub-channels reserved for the PSSCH transmission, (2) estimated channel frequency selectivity, or (3) a QoS requirement such as reliability, latency, priority and minimum communication range (MCR).

For example, if the frequency difference between the sub-channels reserved for the PSSCH transmission and the sub-channels of the CSI-RS transmissions is greater than a frequency threshold (e.g. 20 PRBs) and/or the estimated channel frequency selectivity is greater than a selectivity threshold, a transmitting WTRU may apply an offset (e.g. 1 or 2 units) to reduce the received CQI before applying it to the PSSCH transmission. Also if the QoS requirement, for example reliability of the PSSCH transmission (for example 1E-5), is higher than that associated with the CSI-RS transmission (for example 1E-3), a transmitting WTRU may apply an offset (e.g. 4 or 5 units) to reduce the received CQI before applying it to the PSSCH transmission.

A resource reselection trigger based on a CSI-RS requirement is described herein. In an example, a transmitting WTRU may trigger a resource re-selection when a CSI-RS transmission may be triggered and the PSSCH transmission bandwidth may be below a threshold (e.g. 2 sub-channels).

Examples provided herein include multiple CSI-RS transmissions with a distributed frequency resource. In an example, a transmitting WTRU may request a CSI reporting over a set of CSI-RS transmissions. A transmitting WTRU may select different frequency resource allocations (for example sub-channel) respectively for each of PSSCH transmissions including the CSI-RS transmissions. The purpose may be to span the multiple CSI-RS transmissions over the entire bandwidth. For example, in Mode 1, the base station may schedule a patter-based PSSCH transmission. In Mode 2, a WTRU may select non-overlapping frequency resources spreading over the system bandwidth for the multiple PSSCH/CSI-RS transmissions. A transmitting WTRU may indicate a CSI request in the SCI associated with the last CSI-RS transmission of the multiple CSI-RS transmissions. A receiving WTRU may send a CSI reporting corresponding to the set of CSI-RS transmissions. The CSI reporting may be based on measurements in the bandwidth of each CSI-RS transmission. For example, the receiving WTRU may report the CSI average, the maximum CSI, and/or the minimum CSI of all the measurements.

Examples provided herein include sidelink resource selection based on CSI. In an example, a sidelink mode is disclosed in which a WTRU (or transmitting WTRU) may select a sidelink resource in a resource pool for a sidelink transmission. The sidelink may be referred to as Mode-2. The Mode-2 may be interchangeably used with WTRU selected sidelink mode, WTRU autonomous resource selection mode, WTRU selected mode, WTRU determined resource mode, and sensing based resource selection mode.

Examples provided herein include a subchannel priority. In an example, one or more resource selection schemes (or modes) may be used based on the availability of CSI at a WTRU. For example, if CSI for one or more subchannels in a resource pool is available, a first resource selection scheme may be used. If CSI for one or more subchannels in a resource pool is not available, a second resource selection scheme may be used.

A WTRU may be configured, or indicated to perform one of the resource selection schemes when the WTRU is in Mode-2. Further, a WTRU may perform the first resource selection scheme when the WTRU activates, triggers, or uses CSI feedback for a sidelink transmission (for example, for unicast traffic). Also, a WTRU may perform the second resource selection scheme when the WTRU has no CSI information for one or more subchannels in a resource pool for Mode-2 transmission.

The second resource selection scheme may be used based on one or more of following seven conditions, otherwise the first resource selection scheme may be used: (1) if CSI feedback is configured for a sidelink scheme; (2) if CSI information is available for all subchannels; (3) if CSI information is available for at least N subchannels, wherein the N may be configured, indicated, determined based on the total number of subchannels; (4) if QoS is higher than a threshold; (5) if a WTRU is in-MCR (for example, within minimum communication range); (6) if a retransmission required; (7) if CBR is lower (or higher) than a threshold.

In another example, one or more subchannels may be in a resource pool and a WTRU may determine which subchannel to be used for a sidelink transmission based on one or more of the following parameters: availability of CSI information, validity of CSI information, RSRP of a subchannel, reception of CSI, subchannel reserved by another WTRU, subchannel with PSFCH resource(s), or CQI/RI value of subchannel. Some of the above-mentioned parameters will be described in detail below.

The parameter regarding availability of CSI information is described here. Examples involving CSI information may include CQI, PMI and/or RI. Further, one or more of subchannels in a resource pool may have CSI information or not. For example, a transmitting WTRU may trigger CSI reporting for a subset of subchannels wherein a PSSCH may be transmitted and the other subchannels may not have a CSI at the time when a WTRU determines one or more subchannels for a sidelink transmission. Further, a subchannel with CSI information may have a higher priority than a subchannel without CSI information. For example, if one or more subchannels are candidates for a resource selection, a subchannel with CSI information may be considered to have a higher priority than a subchannel without CSI information.

The parameter regarding validity of CSI information is described here. If CSI is received after a time threshold, the CSI may be considered as out-dated and a WTRU may consider (or assume) that the CSI is not valid. Therefore, the same priority as that of a subchannel without CSI may be used or assumed. Also, a subchannel with CSI which is received after than a time threshold may have a lower priority (or a higher priority) for a resource selection than a subchannel with CSI received before the time threshold. Moreover, a time gap between a CSI reception and resource selection may be referred to as CSI validity gap (CVG) and a CSI received for a subchannel with longer CVG may be less accurate than a CSI received for a subchannel with shorter CVG. A subchannel with shorter CVG may have a higher priority than another subchannel with longer CVG for a resource selection if the one or more subchannels have the same priority.

The parameter regarding RSRP of a subchannel is described here. For example, a WTRU may measure RSRP of one or more subchannels in a resource pool and select a first subset of subchannels of which RSRP may be lower than a threshold (e.g. a threshold corresponding to −10 dBm). Then, the WTRU may determine a second subset of subchannels from the first subset of subchannels based on the availability of CSI of each subchannel and/or CVG of each subchannel. If there is still more than one subchannel in the second subset of subchannels, the WTRU may randomly determine, within the second subset of subchannels, which subchannel to be used for a sidelink transmission.

The parameter regarding reception of SCI is described here. For example, a WTRU may blindly decode SCI in each subchannel and if the WTRU received an SCI in a subchannel and the WTRU may exclude the subchannel from the first set of subchannels.

The parameter regarding subchannel reserved by another WTRU is described here. A subchannel may be reserved by another WTRU and the QoS of the reserved resource may be lower than the QoS of packet a transmitting WTRU may send on sidelink. This subchannel resource may be selected for a sidelink transmission and referred to as a reserved subchannel with lower QoS (RSLQ). In addition, a subchannel without reservation may be referred to as non-reserved subchannel (NRS). Further, in a Mode-2 resource selection, RSLQ may have a lower priority (or a higher priority) than NRS. If RSLQ has CSI information and a NRS has no CSI information, the RSLQ may have a higher priority than the NRS. In another example, irrespective of valid CSI on a subchannel, RSLQ may have a lower priority (or a higher priority) than NRS.

The parameter regarding subchannel with PSFCH resource is described here. A subchannel with PSFCH resource may have a lower priority than a subchannel without PSFCH resource. For example, in a slot, a first subset of subchannels may have a PSFCH resource while a second subset of subchannels may have no PSFCH resource, wherein the second subset of subchannels may have a higher priority than the first subset of subchannels. In an example, a WTRU may first measure RSRP of one or more subchannels in a resource pool and determine a first subset of subchannels which may have a RSRP lower than a threshold. Then, the WTRU may determine a second subset of subchannels which may not have PSFCH resource in the slot. If the second subset of subchannels has more than one subchannel, the WTRU may randomly select one or more subchannels from the second subset of subchannels for a sidelink transmission.

The parameter regarding CQI/RI value of subchannel is described here. A subchannel priority may be determined based on CQI/RI value of each subchannel. A subchannel with a higher CQI/RI value may have a higher priority than a subchannel with a lower CQI/RI value.

It should be noted that the terms “first” and “second” used in the above-discussed first subset of subchannels and the second subset of subchannels are only given for the purpose of differentiating these two subset of subchannels from each other, and thus they are not intended to be limiting to the present disclosure. For example, a first subset of subchannels may be used as a second subset of subchannels and the second subset of subchannels may be used as the first subset of subchannels, and still be consistent with the examples and embodiments provided herein.

Examples including subchannel sensing are described here. In an example, a WTRU may perform sensing for the subchannels with a valid CSI information while the WTRU may skip performing sensing for the subchannels without a valid CSI, wherein the valid CSI information may include one or more of the following parameters: an associated CSI, a CSI received less than x slot earlier, or a CQI/RI value higher than a threshold. Some of the above-mentioned parameters will be described in detail below. An associated CIS may be, for example, CQI, PMI and/or RI. Further, examples involving a CSI received less than x slot earlier may include a WTRU performing sensing. For example, if a WTRU performs sensing in a slot #n for a subchannel, a CSI for the subchannel may be received later than slot #n-x. Further, the x may be determined based on one or more of these parameters: mobility; QoS (for example, latency requirement); or transmission cast type (for example, groupcast or unicast).

Examples including sidelink CSI reporting are included herein. A receiving WTRU may report a CSI corresponding to a received CSI-RS based on one or more of the following parameters: (1) CSI request indicated in the SCI associated with the CSI-RS transmission; (2) CSI presence indicated in the SCI associated with the CSI RS transmission; (3) CBR; or (4) MCR. Some of the above-mentioned parameter will be further described below.

For example, when a receiving WTRU receives SCI indicating that a CSI-RS is present without a CSI request, the receiving WTRU may measure the CSI based on the indicated CSI-RS and store the measurement result without reporting the CSI. In another example, a CSI presence may be indicated in the SCI associated with the CSI-RS transmission. In a further example, when a receiving WTRU measures an out-of-range CQI value, the receiving WTRU may send the CQI when the CBR is lower than a threshold. Otherwise, the receiving WTRU may not send the CQI. Also, for example, when a receiving WTRU are out-of-MCR, the receiving WTRU may not send the CSI report.

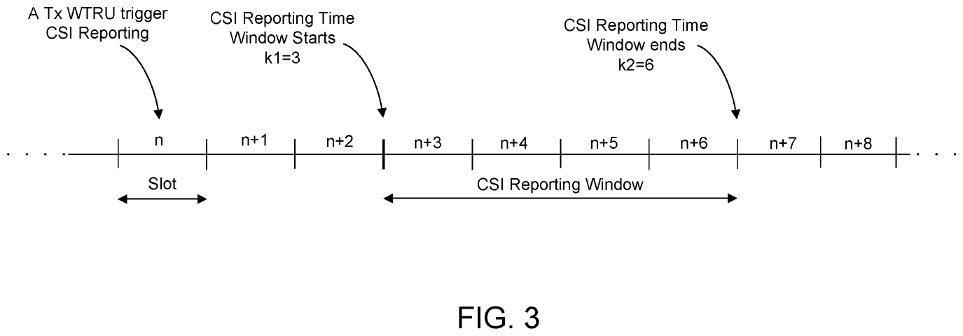

CSI reporting time window will be described below with reference to FIG. 3. FIG. 3 is a timing diagram illustrating an example of a CSI reporting time window. As shown in FIG. 3, a receiving WTRU may be required to report CSI triggered by a transmitting WTRU within a time window, wherein the time window may start from the slot #n+k1 and end at the slot #n+k2 when the CSI reporting is triggered at the slot #n. The time window herein may be referred to as CSI reporting time window (CSI-TW). One or more of following examples may apply.

For example, k1 and k2 may be a non-negative integer number, i.e., k1≥0, k2≥0. Also, each of k1 and k2 may be a predefined number (for example, k1=4).

In a further example, k1 may be determined based on a processing capability of the WTRU. For example, a first WTRU may have a greater processing capability so that it may process faster (for example, k1=2) while a second WTRU may have a less processing capability so that it may not process faster (for example, k1=4). The processing capability (for example, k1 value) may be indicated via PC5-RRC during RRC connection setup.

In another example, k2 may be determined as a function of k1. For example, k2=k1+Xk, wherein Xk may be determined based on one or more of the following parameters: (1) one or more of QoS parameters, (2) CBR, (3) MCR, (4) coverage, (5) mode, (6) cast type or (7) maximum rank. Some of the above-mentioned parameters will be described below. In an example, if the CBR is smaller than a threshold, a first Xk may be used. Otherwise, a second Xk may be used. The first Xk may be smaller than the second Xk. In an example using the MCR, in-MCR and/or out-MCR may be used. In an example using the coverage, in-coverage or out-of-coverage may be used. In an example using the Mode, Mode-1, Mode-2 or both may be used. In an example using the transmission cast type, groupcast, unicast or both may be used.

In an additional example, k1 may be determined as a function of one or more of the following parameters: (1) the number of subchannels, (2) the number of CSI processes, or (3) configured CSI feedback. For example, the number of subchannels may be a total amount of subchannels in a pool. In an example, the number of subchannels may be the number of subchannels which have been allocated for CSI-RS transmission. In an example, the number of subchannels may be the number of subchannels used for PSSCH transmission.

In examples including the number of CSI processes, a CSI process may be a CSI measurement for a CSI-RS transmission. A WTRU may be requested to measure more than one CSI-RS at a time, for example, from same WTRU or different WTRUs. Therefore, there may be multiple CSI processes.

In examples including configured CSI feedback, a set of CSI feedback types may be used. For example, a different subset of CSI feedback types (for example, CQI, PMI, RI, L1-RSRP, etc.) may be configured.

In a further example, k1 and/or k2 may be indicated in the associated SCI for CSI feedback triggering. Further, k1 and/or k2 may be determined based on one or more of the following parameters: one or more of QoS parameters, CBR, MCR (for example, in-MCR or out-MCR), coverage (for example, in-coverage or out-of-coverage), Mode (Mode-1 or Mode-2), transmission cast type (for example, groupcast or unicast); and/or maximum rank.

In an example, when a receiving WTRU may not be able to report triggered CSI within the time window (for example, between slot #n+k1 and slot #n+k2), at least one of following events may happen: (1) the receiving WTRU may drop the triggered CSI reporting; (2) the receiving WTRU may indicate to the transmitting WTRU that the previously triggered CSI reporting has been dropped; or (3) the receiving WTRU may increase k2 value if QoS of a traffic is higher than a threshold.

CSI report triggering with reporting time window will be described below. In an example, a transmitting WTRU may be allowed to trigger a receiving WTRU to do sidelink CSI reporting up to N times within a time window. The time window may be a CSI reporting time window (CSI-TW). The number N may be determined based on one or more of the following examples.

In an example, N may be the same as the number of slots within the CSI-TW.

In an example, N=1 may be hold true for the same subchannel. For example, a transmitting WTRU may trigger a single CSI reporting for a subchannel within the time window. A receiving WTRU may not expect to receive a CSI reporting trigger for a same subchannel more than one time within the time window. Further, if the receiving WTRU received multiple CSI reporting triggers for a same subchannel within a time window, the receiving WTRU may ignore the reporting triggers or the WTRU may only report a single CSI reporting for the one or more CSI reporting triggers.

In an example, N may be predetermined or configured. In an example, N may be determined based on the time window length or the number of slots within the time window.

In another example, a time window may be configured, determined, or used for a triggering of a CSI reporting and/or CSI-RS transmission. In each time window, a WTRU may trigger a single CSI reporting and/or CSI-RS transmission.

The time window may be used or determined per one or more subchannels (or a group of subchannels). Therefore, if a transmitting WTRU triggers a receiving WTRU to do a CSI reporting for a subchannel, then the transmitting WTRU may not be allowed to trigger the same receiving WTRU to do the CSI reporting for the same subchannel within the time window. However, the transmitting WTRU may trigger the same receiving WTRU to do another CSI reporting for a different subchannel. Alternatively, the transmitting WTRU may trigger a different receiving WTRU to do another CSI reporting for the same subchannel within the time window.

The time window may be determined or configured per resource pool, WTRU, and/or mode of operation (for example, Mode-1, Mode-2). Further, the time window may be determined based on one of more of the following parameters: one or more of QoS parameters, CBR, MCR (for example, in-MCR or out-MCR), coverage (for example, in-coverage or out-of-coverage), Mode (Mode-1 or Mode-2) transmission cast type (for example, groupcast or unicast), maximum rank, and/or mobile speed which may be considered to be the relative speed between two WTRUs. Further, the time window may be determined based on the number of slots available for sidelink transmission.

Dropping of triggered CSI reporting will be described below. In an example, a receiving WTRU may drop a triggered CSI reporting when one or more of following events occur.

In a first event, a receiving WTRU may drop one or more received CSI reporting triggers if the number of triggered CSI reporting is more than Z within a time window, where in Z may be determined based on one or more of the following parameters: a WTRU capability, a CBR range or CBR of the resource pool, a coverage (in-coverage or out-of-coverage), or a mode of operation.

In a second event, a receiving WTRU may determine which CSI reporting to drop based on one or more of the following parameters: the latest CSI reporting trigger, the CSI with lowest CQI value, QoS, CBR, and/or MCR of an associated PSSCH which may include the CSI-RS, mode, or cast type of an associated PSSCH which may include the CSI-RS, or maximum rank or mobile speed.

In a third event, a transmitting WTRU may indicate a priority level of the CSI reporting when the WTRU triggers the CSI reporting. The priority level may be separately indicated from the priority level of the PSSCH transmission. If a CSI reporting is triggered, a receiving WTRU may determine whether to drop the CSI reporting based on the priority level of the CSI reporting.

CSI reporting on PSSCH will be described below. In an example, a receiving WTRU may send the CSI reporting bits multiplexed with a PSSCH transmission. A receiving WTRU may determine the resource allocation and coding rate of the CSI reporting bits based on a QoS requirement associated with the CSI-RS transmission, a PSSCH transmission MCS, a PSSCH DMRS configuration, and/or an estimated path loss between the transmitting WTRU and the receiving WTRU. In an example, the QoS requirement associated with the CSI-RS transmission may be indicated in the SCI of the CSI-RS transmission. In an example, the QoS requirement associated with the CSI-RS transmission may be the same as the PSSCH transmission accompanying the CSI-RS transmission. In an example, the QoS requirement associated with the CSI-RS transmission may be indicated in the density and/or resource allocation of the CSI-RS transmission.

A receiving WTRU may indicate in the SCI the presence of CSI reporting in the PSSCH transmission. In an example, a receiving WTRU may send the CSI reporting in a PSSCH without user data. Due to the small payload of the CSI reporting, a receiving WTRU may use a sub-set of resource of a PSSCH resource, for example sub-channels and/or symbols. A receiving WTRU may indicate the resource allocation with the sub-channel in the SCI associated with the PSSCH transmission. The selection of such sub-set of resources may be based on the CSI-RS and its accompanying PSSCH transmission resource (e.g., the CSI-RS and/or PSCCH sub-channel number, slot number and/or WTRU L1 ID information).

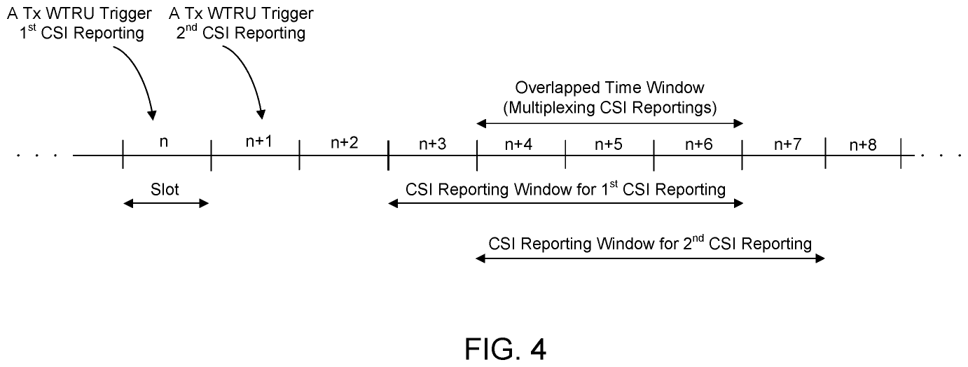

Multiplexing of multiple CSI reportings is described below. FIG. 4 is a timing diagram illustrating an example of multiplexing of multiple CSI reportings. A receiving WTRU may receive one or more CSI reporting triggers and the receiving WTRU may be required to report more than one CSI reporting at a time. A receiving WTRU may receive a consecutive multiple CSI reporting triggers and the CSI reporting time window may be overlapped as shown in an example in FIG. 4. During the overlapped time window, the receiving WTRU may report more than one CSI reporting. Further, the receiving WTRU may receive CSI reportings from more than one transmitting WTRU, and the CSI reporting time window may be fully or partially overlapped.

In an example, one or more CSI reportings may be multiplexed on a PSCCH transmission. For example, one or more CSI reportings may be concatenated as a payload with a CSI reporting index. The one or more CSI reportings may be concatenated if the one or more CSI reportings are targeting the same WTRU, for example, same transmitting WTRU.

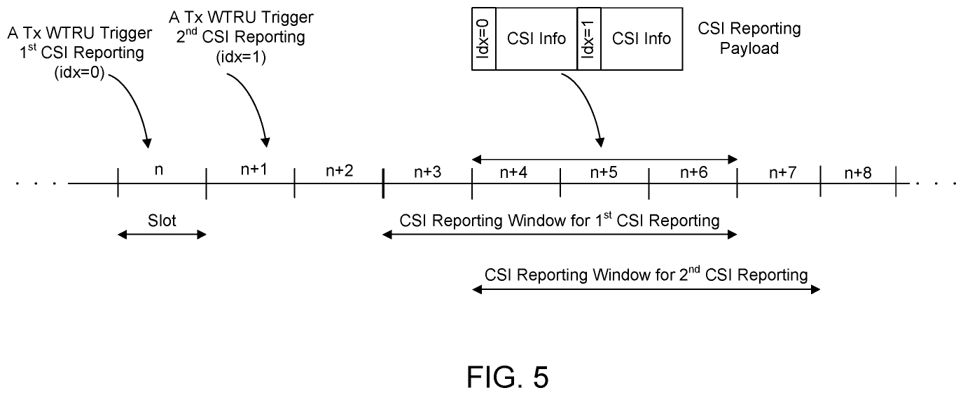

FIG. 5 is a timing diagram illustrating an example of multiplexed CSI reportings with a CSI reporting index. As shown in FIG. 5, a payload may include one or more CSI information and each CSI information may include a CSI reporting index. The multiplexed CSI reportings may be transmitted or reported by a receiving WTRU on PSSCH/PSCCH.

The CSI reporting index may be indicated based on at least one of following ways: (1) an index may be included in the associated SCI; and (2) an index may be determined based on one or more of following parameters: a slot or a subframe index in which the CSI reporting triggered, a subchannel index, a source-id, or a destination-id. In examples, a subchannel with the subchannel index may include the associated PSCCH/PSSCH. Further, the first or the last subchannel of a set of subchannels may be used if more than one subchannel is used.

In an example, one or more CSI reportings may be multiplexed within a subchannel, wherein a subchannel may have one or more resource blocks (RBs) and OFDM symbols. In an example, an FDM of CSI reportings may be performed. In an example, one or more CSI reportings may be multiplexed in different frequency resources. For example, the first CSI reporting may be transmitted in the first RB within a subchannel and the second CSI reporting may be transmitted in the second RB within the subchannel. In another example, a first set of RBs may be used for the first CSI reporting and a second set of RBs may be used for the second CSI reporting.

In an example, a TDM of CSI reportings may be performed. For example, one or more CSI reportings may be multiplexed in different OFDM symbols.

In an example, both an FDM and a TDM of CSI reportings may be performed. For example, one or more CSI reportings may be multiplexed in different RBs and OFDM symbols.

The associated time/frequency resource within a subchannel for a CSI reporting (for example, a CSI reporting index) may be determined based on a CSI reporting index, a source-id and/or a destination-id, and/or a subchannel index.

In another example, a WTRU may report the latest CSI reporting trigger if multiple CSI reportings are triggered for a same subchannel. Otherwise, a WTRU may multiplex one or more CSI reporting triggers and report if multiple CSI reportings are triggered for different subchannels.

A WTRU may report the latest CSI trigger if one or more CSI reportings have been triggered on a same subchannel. A WTRU may report multiple CSI reportings multiplexed if one or more CSI reportings have been triggered on different subchannels. A WTRU may report CSI reporting in different time if one or more CSI reportings have been triggered on different subchannels.

Examples provided herein may include priority of CSI reporting and other transmissions. A WTRU may need to transmit one or more sidelink transmissions in a slot, wherein the WTRU may transmit a subset of sidelink transmissions. Each sidelink transmission may be at least one of PSCCH/PSSCH, PSFCH, S-SSB, and/or PSBCH.

In an embodiment, if one or more sidelink transmissions are based on PSCCH/PSSCH, a first PSSCH may have a higher priority than a second PSSCH.

In an example, the first PSSCH may be a PSSCH including both CSI and sidelink packet from a higher layer and the second PSSCH may be a PSSCH including CSI only (i.e., not including sidelink packet) from a higher layer. A PSSCH including CSI only may have a lower priority than a PSSCH including both CSI and sidelink packet (i.e., the second PSSCH may have a lower priority than the first PSSCH). If a WTRU needs to drop one or more sidelink transmissions, a PSSCH having a lower priority may be dropped.

In an example, the first PSSCH may be a PSSCH including both CSI and sidelink packet from a higher layer and the second PSSCH may be a PSSCH including sidelink packet only (i.e., not including CSI) from a higher layer. A PSSCH including both CSI and sidelink packet may have a higher priority than a PSSCH including sidelink packet only (i.e., the second PSSCH may have a lower priority than the first PSSCH). If a WTRU needs to drop one or more sidelink transmissions, a PSSCH having a lower priority may be dropped.

In an example, the first PSSCH may be a PSSCH including sidelink packet only (i.e. not including CSI) from a higher layer and the second PSSCH may be a PSSCH including CSI only (i.e., not including sidelink packet) from a higher layer. A PSSCH including CSI only may have a lower priority than a PSSCH including sidelink packet only (i.e., the second PSSCH may have a lower priority than the first PSSCH). If a WTRU needs to drop one or more sidelink transmissions, a PSSCH having a lower priority may be dropped.

In another example, if one or more sidelink transmissions are based on PSSCH including CSI only, the priority of one or more PSSCHs may be determined based on one or both of the following two ways. First, a PSSCH including CSI only for a higher QoS (for example, priority level) may have a higher priority than a PSSCH including CSI only for a lower QoS (for example, priority level). The QoS may be the QoS of PSSCH transmitted together with CSI-RS for CSI reporting. Also, the QoS may be indicated in SCI which may trigger the CSI reporting. Second, a CSI with a higher CQI/RI may have a higher priority.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1-15. (canceled)

16. A method for use in a first wireless transmit/receive unit (WTRU), the method comprising:
receiving, from a second WTRU, via sidelink signaling, a message indicating a latency bound for sending a sidelink-channel state information (SL-CSI) report;
receiving an indication to transmit the SL-CSI report; and
on a condition that the first WTRU is able to transmit the SL-CSI report in obtained resources within the latency bound indicated in the sidelink signaling, transmitting the SL-CSI report.

17. The method of claim 16, wherein the sidelink signaling is a PC5-radio resource control (PC5-RRC) signaling.

18. The method of claim 16, further comprising:
selecting a scheduling request (SR) configuration from a set of SR configurations received via sidelink RRC signaling; and
transmitting a SR based on the SR configuration.

19. The method of claim 16, wherein the WTRU is configured with a mapping of a set of SR configurations to a pre-configured CSI reporting latency information set.

20. The method of claim 16, wherein the CSI report is transmitted using a SL resource indicated in a SL grant.

21. The method of claim 16, further comprising transmitting a computed latency for the SL-CSI report.

22. The method of claim 21, wherein the computed latency is transmitted using a SR transmission or a control message.

23. The method of claim 21, wherein the computed latency may be transmitted using a physical uplink control channel resource which is associated with the computed latency.

24. A first wireless transmit/receive unit comprising:
a receiver; and
a transmitter;
wherein the receiver is configured to receive, via sidelink signaling, a message indicating a latency bound for sending a sidelink-channel state information (SL-CSI) report from a second WTRU;
wherein the receiver is further configured to receive an indication to transmit the SL-CSI; and
wherein, on a condition that the first WTRU is able to transmit the SL-CSI report in obtained resources within the latency bound indicated in the sidelink signaling, the transmitter is configured to transmit the SL-CSI report.

25. The WTRU claim 24, wherein the sidelink signaling is a PC5-radio resource control (PC5-RRC).

26. The WTRU of claim 24, wherein transmitting the SL-CSI report comprises:
selecting a scheduling request (SR) configuration from a set of SR configurations received via sidelink RRC signaling; and
transmitting a SR based on the SR configuration.

27. The WTRU of claim 24, wherein the WTRU is configured with a mapping of a set of SR configurations to a pre-configured CSI reporting latency information set.

28. The WTRU of claim 24, wherein the CSI report is transmitted using a SL resource indicated in a SL grant.

29. The WTRU of claim 24, further comprising transmitting a computed latency for the SL-CSI report.

30. The WTRU of claim 29, wherein the computed latency is transmitted using a SR transmission or a control message.

31. The WTRU of claim 29, wherein the computed latency may be transmitted using a physical uplink control channel resource which is associated with the computed latency.
